(19) United States
(12) Patent Application Publication
(10) Pub. No.: US 2024/0178465 A1
(43) Pub. Date: May 30, 2024

(54) Grinder

(71) Applicant: Zhuhai Kelitong Electronic Co., Ltd., Zhuhai City (CN)

(72) Inventors: Song Xiaoxian, Zhuhai City (CN); Zhu Wei, Zhuhai City (CN); Luo Haifeng, Zhuhai City (CN)

(21) Appl. No.: 18/214,934

(22) Filed: Jun. 27, 2023

(30) Foreign Application Priority Data
Nov. 27, 2022 (CN) 202223148034.4

(51) Int. Cl. H01M 10/42; B24B 23/00; H01M 50/284; H02J 7/00

(52) U.S. Cl. CPC H01M 10/425; B24B 23/00; H01M 50/284; H02J 7/0045; H01M 2220/30

(57) ABSTRACT

The present invention discloses a grinder, comprising an upper shell, a lower shell, a PCB, a charging contact piece and a battery, wherein the lower end of the upper shell is connected to the upper end of the lower shell, the PCB is electrically connected to the battery, one end of the charging contact piece is electrically connected to the PCB, the battery and the PCB are both connected to the inside of the upper shell, and the other end of the charging contact piece protrudes from and is exposed on the side of the upper shell. In the present invention, the charging contact piece is provided on the side of the grinder to realize side contact charging, the structures related to the charging function are provided in the upper shell, and providing the structures related to the switched-on circuit in the lower shell is avoided.

### CROSS-REFERENCE TO RELATED APPLICATION

This application claims priority to Chinese Patent Application 202223148034.4 filed on Nov. 27, 2022, the entire contents of which are hereby expressly incorporated by reference into the present application.

### TECHNICAL FIELD

The present invention generally relates to the technical field of grinding and in particular to a grinder.

### BACKGROUND

For grinders currently available on the market, one contact charging mode is that a charging contact piece is provided at the lower end of the grinder, and a base with a power supply contact piece is provided, so that when the lower of the grinder is placed on the base, the charging contact piece at the lower end of the grinder contacts the power supply contact piece to charge the grinder.

The problem is that since the ground material is usually discharged from the lower end of the grinder, which means that the discharge port of the grinder is in place on the base, and grinding powder dropping out of the discharge port is likely to result in bad contact of the charging contact piece. In addition, setting up a circuit conduction structure for charging at the lower end of the grinder will make the lower part of the grinder complex in structure and difficult to design.

What is needed is a grinder that addresses any of the shortcomings of the prior art discussed above.

### SUMMARY

The present invention provides a grinder that is realized through the following technical solution:

A grinder, comprising an upper shell, a lower shell, a PCB, a charging contact piece and a battery, wherein the lower end of the upper shell is connected to the upper end of the lower shell, the PCB is electrically connected to the battery, one end of the charging contact piece is electrically connected to the PCB, the battery and the PCB are both connected to the inside of the upper shell, and the other end of the charging contact piece protrudes from and is exposed on the side of the upper shell.

Further, the upper shell comprises an inner left shell, an inner right shell and an upper bottom cap, wherein the inner left shell and the inner right shell are mounted by covering, the battery and the PCB are built in and connected to the inner left shell or the inner right shell, the other end of the charging contact piece protrudes from and is exposed on the side of the inner left shell or the inner right shell, the upper end of the upper bottom cap is connected to the inner left shell and the inner right shell, and the lower end of the upper bottom cap is connected to the upper end of the lower shell.

Further, the lower shell comprises a feed bin, a limit bulge is provided on the outer side of the upper end of the feed bin, a limit groove is provided inside the lower end of the upper bottom cap, one end of the limit groove bends down and opens, the other end of the limit groove extends circumferentially inside the lower end of the bottom cap, and the limit bulge and the limit groove are connected in a matched manner.

Further, a driving shaft and a snap spring are also provided, the lower shell also comprises a bracket, the bracket is connected to the lower end of the feed bin, the snap spring is connected to the middle of the driving shaft, the driving shaft passes through the middle fixing hole of the bracket, and the snap spring abuts against the middle fixing hole of the bracket.

Further, a male grinding head and a female grinding head are provided, the lower shell also comprises a lower bottom cap, the upper end of the lower bottom cap is connected to the lower end of the bracket, the male grinding head is connected to the lower end of the driving shaft, the female grinding head is connected inside the lower bottom cap, and the male grinding head is located inside the female grinding head.

Further, a fool-proof bulge is provided inside the lower end of the lower bottom cap.

Further, the lower shell also comprises a lower casing, and the lower casing fits over the outside of the lower bottom cap.

Further, the PCB comprises a master PCB and a charging PCB, the battery is electrically connected to the master PCB or the charging PCB, and one end of the charging contact piece is electrically connected to the charging PCB.

Further, a motor is also provided, connected inside the upper shell, and electrically connected to the PCB.

Further, the charging contact piece is a flexible charging cable.

Such design has the following advantages: The present invention provides a grinder, wherein the charging contact piece is provided on its side to realize side contact charging, the structures related to the charging function are provided in the upper shell, and providing the structures related to the switched-on circuit in the lower shell is avoided.

These and other aspects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof. It is hereby disclosed that the invention includes all such modifications.

### BRIEF DESCRIPTION OF THE DRAWINGS

FIG. 1 is an overall structural diagram of the grinder and the base;

FIG. 2 is an exploded view of the driving component of the present invention;

FIG. 3 is an exploded view of the grinding component of the present invention;

FIG. 4 is an exploded view of the base;

FIG. 5 is a vertical sectional view of the grinder and the base;

FIG. 6 is a three-dimensional structural diagram of the upper bottom cap;

FIG. 7 is a three-dimensional structural diagram of the lower bottom cap.

Where: 1) driving component; 11) upper shell; 111) inner left shell; 112) inner right shell; 113) upper bottom cap; 1131) limit groove; 114) upper casing; 12) motor; 13) battery; 14) master PCB; 15) charging PCB; 16) charging contact piece; 2) grinding component; 21) lower shell; 211) lower casing; 212) feed bin; 2121) limit bulge; 213) lower bottom cap; 2131) fool-proof bulge; 22) bracket; 23) driving shaft; 24) snap spring; 25) male grinding head; 26) female grinding head; 3) upper base; 31) upper base upper cap; 311) lateral recess; 32) upper base lower cap; 4) lower base; 41) fixing rib; 42) fool-proof groove; 43) inner recess; 5) power supply PCB; 6) power supply contact piece; 7) external charging interface; 8) buckle position.

### DETAILED DESCRIPTION

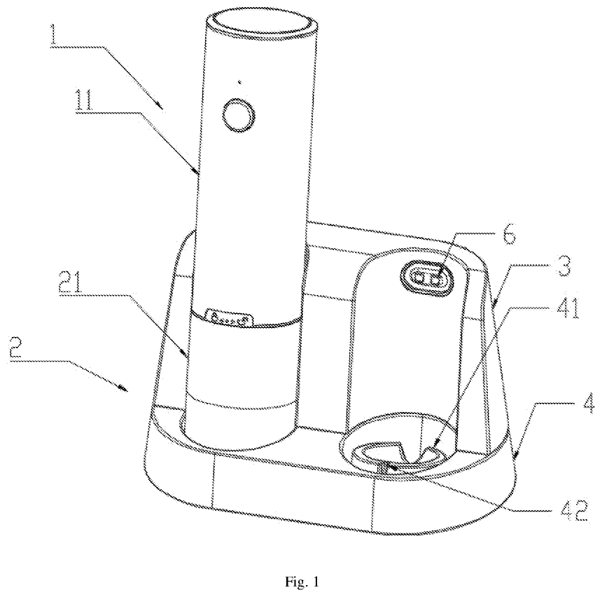

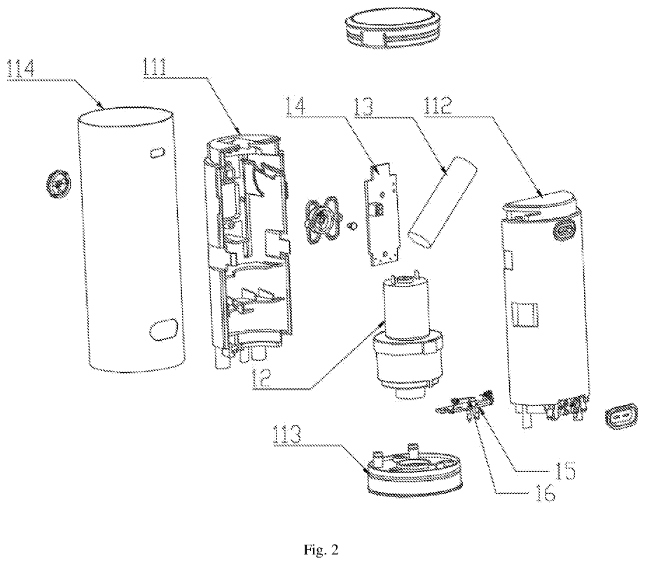

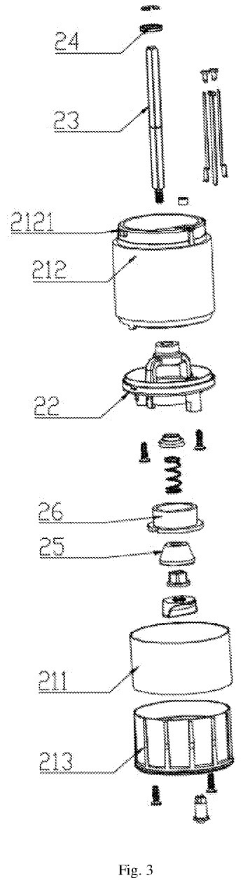

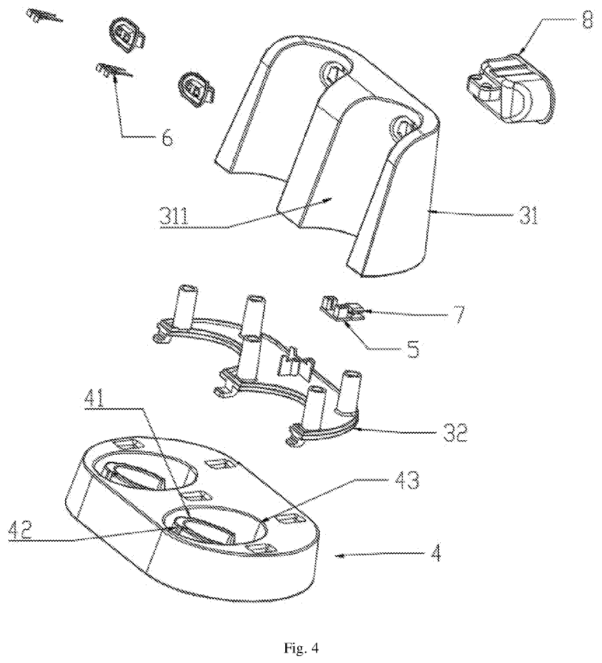

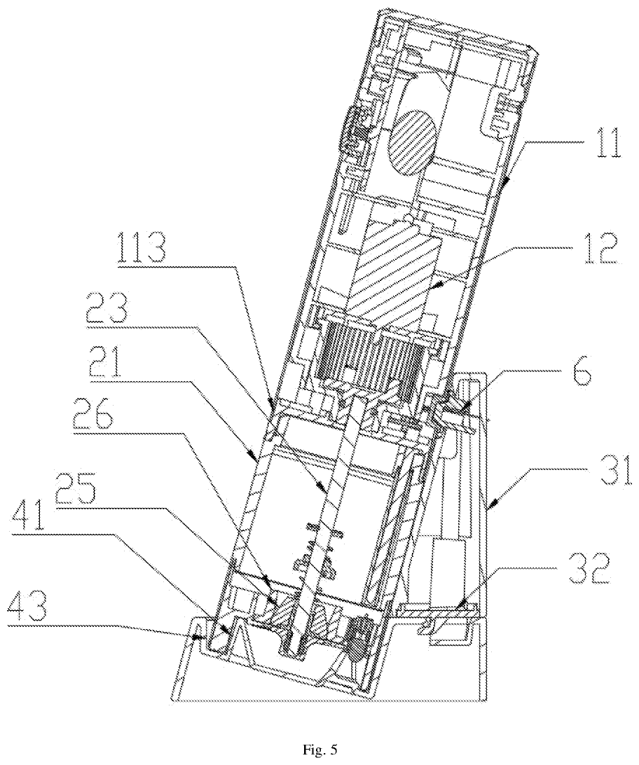

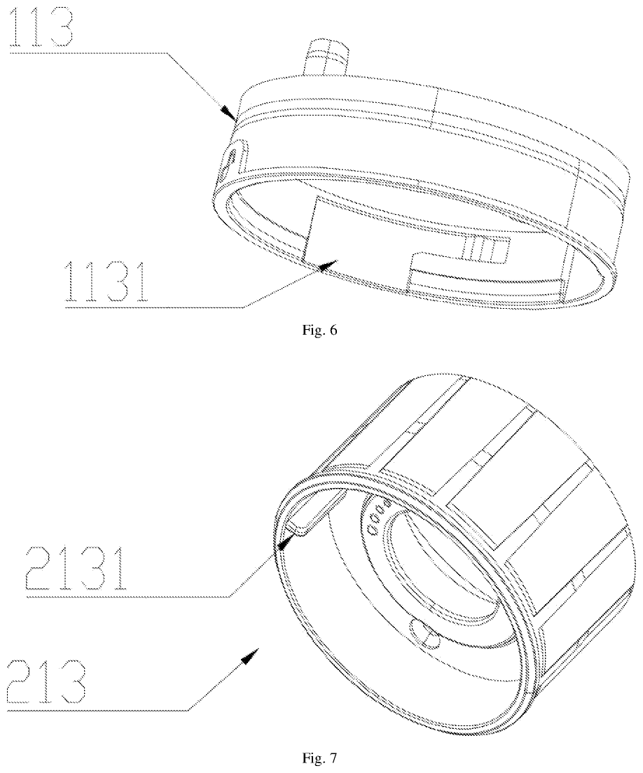

As shown in FIG. 1 to FIG. 7, the present embodiment provides a contact charging device for grinders, comprising a grinder and a base, wherein when the body of the grinder is connected to the base, the base can charge the grinder.

The grinder comprises a driving component 1 and a grinding component 2.

The driving component 1 comprises an upper shell 11, a motor 12, a battery 13, a master PCB 14 and a charging PCB 15, wherein the motor 12, the battery 13 and the charging PCB 15 are built in and connected inside the upper shell 11. The master PCB 14 is electrically connected to the charging PCB 15, the master PCB 14 and the charging PCB 15 can be combined into one PCB, and the battery 13 is electrically connected to the master PCB14 or the charging PCB 15, and used to supply power to the master PCB 14, the charging PCB 15 and the motor 12.

A charging contact piece 16 is provided on the charging PCB 15, one end of the charging contact piece 16 is electrically connected to the charging PCB 15, and the other end of the charging contact piece 16 protrudes from the side of the upper shell 11. The charging contact piece 16 is used to contact and connect the power supply contact piece 6 on the base, and the power supply contact piece 6 can charge the battery 13 through the charging contact piece 16, the master PCB 14 and the charging PCB 15. The charging contact piece 16 is preferably a flexible charging cable.

The upper shell 11 comprises an inner left shell 111, an inner right shell 112, an upper bottom cap 113 and an upper casing 114. The inner left shell 111 and the inner right shell 112 are mounted by covering, the upper bottom cap 113 is connected to the lower end of the inner left shell 111 and the inner right shell 112, and the upper casing 114 fits over the outside of the inner left shell 111 and the inner right shell 112. The motor 12, the battery 13 and the charging PCB 15 are built in the inner left shell 111 and the inner right shell 112, the charging PCB 15 is connected to the upper bottom cap 113, the other end of the charging contact piece 16 protrudes from the hole of either the inner right shell 112 or the inner left shell 111 and the hole on the upper casing 114, the motor 12 is mounted on the inner left shell 111 and the inner right shell 112, and the master PCB and the battery 13 are connected to the inner left shell 111 or the inner right shell 112.

All circuit-related structures are contained in the upper shell 11, providing the structures related to the switched-on circuit in the lower shell 21 is avoided, and structures not related to the charging function may be provided in the lower shell 21, such as mechanical transmission structures.

The grinding component comprises a lower shell 21, a bracket 22, a driving shaft 23, a snap spring 24, a male grinding head 25 and a female grinding head 26.

The lower shell 21 comprises a lower casing 211, a feed bin 212 and a lower bottom cap 213, wherein a limit bulge 2121 is provided on the outer side of the upper end of the feed bin 212, a limit groove 1131 is provided inside the lower end of the upper bottom cap 113, one end of the limit groove 1131 bends down and opens, the other end of the limit groove 1131 extends circumferentially for a certain distance inside the lower end of the bottom cap, and the limit bulge 2121 can be inserted into the limit groove 1131 and moves in the direction of the limit groove 1131 to realize connection or detachment between the feed bin 212 and the bottom cap, so that the material to be ground may be added to the feed bin 212 in the detached state.

The bracket 22 is connected to the lower end of the feed bin 212, the driving shaft 23 passes through the middle fixing hole of the bracket 22, the bracket 22 restricts the radial motion of the driving shaft 23, the snap spring 24 is clamped in the middle of the driving shaft 23, and the snap spring 24 abuts against the middle fixing hole of the bracket 22, so that the bracket 22 also restricts the axial motion of the driving shaft 23.

The upper end of the lower bottom cap 213 is connected to the lower end of the bracket 22, the female grinding head 26 is connected inside the lower bottom cap 213, the male grinding head 25 is connected to the lower end of the driving shaft 23, and the upper end of the driving shaft 23 is connected to the motor 12, so that the motor 12 can drive the male grinding head 25 to rotate through the driving shaft 23, and the male grinding head 25 is located inside the female grinding head 26. Therefore, when the male grinding head 25 rotates relative to the female grinding head 26, the material passed through is ground into particles between the male grinding head 25 and the female grinding head 26, and drops out of the lower bottom cap 213. A fool-proof bulge 2131 is provided inside the lower end of the lower bottom cap 213, and used to align the fool-proof groove 42 on the base, so that the charging contact piece 16 can be aligned with the power supply contact piece 6.

The lower casing 211 fits over the lower bottom cap 213, and is used to decorate the lower bottom cap 213.

The base comprises a lower base 4, an upper base 3, a power supply PCB 5, a power supply contact piece 6 and an external charging interface 7, and the upper base 3 comprises an upper base upper cap 31 and an upper base lower cap 32.

The upper base lower cap 32 is connected to the bottom of the upper base upper cap 31, the power supply PCB 5 is built in the upper base upper cap 31 and the upper base lower cap 32, and the power supply PCB 5 is connected to the upper base lower cap 32.

A lateral recess 311 is provided in the upper base upper cap 31, and used to place the grinder.

One end of the power supply contact piece 6 is electrically connected to the power supply PCB 5, and the other end of the power supply contact piece 6 protrudes from the inside of the lateral recess 311. The external charging interface 7 is electrically connected to the power supply PCB 5, protrudes from the upper base upper cap 31, and is used to connect the external power supply.

The lower base 4 is detachably connected to the lower end of the upper base lower cap 32. Specifically, a plurality of fasteners are provided at the end of the upper base lower cap 32 close to the lower base 4, a plurality of catching grooves are provided on the side of the lower base 4 close to the upper base lower cap 32, and the upper base lower cap 32 and the lower base 4 are connected by a buckle, so that through the buckle connection, the upper base 3 and the lower base 4 can also be detached.

The upper surface of the lower base 4 sags downward to form an inner recess 43, and the inner recess 43 is aligned with the lower end of the lateral recess 311, and used to insert the lower bottom cap 213, so that one end of the grinder can be fixed on the inner recess 43. The bottom surface of the inner recess 43 tilts increasingly deeply downward toward the upper base upper cap 31, so that the grinder mounted on the inner recess 43 tilts toward the lateral recess 311, and the side of the grinder abuts against the lateral recess 311. An upwardly bulging fixing rib 41 is provided on the bottom surface of the inner recess 43, and used to be inserted into the inside of the lower bottom cap 213 to assist in fixing the lower bottom cap 213. A fool-proof bulge 2131 is provided on the fixing rib 41 close to the lower bottom cap 213, a fool-proof groove 42 is provided on the lower bottom cap 213, and the fool-proof bulge 2131 and the fool-proof groove 42 match each other, so that the charging contact piece 16 can be aligned with the power supply contact piece 6.

A buckle position 8 is connected to the side of the upper base upper cap 31 away from the lateral recess 311, and used to take up the base.

The charging mode of the present invention is as follows:

The lower end of the grinder is inserted into the inner recess 43, i.e., the lower bottom cap 213 is inserted into the inner recess 43, and the fixing rib 41 is inserted into and matches the inside of the lower bottom cap 213. Since the bottom surface of the inner recess 43 tilts toward the lateral recess 311, the side of the grinder can abut against the lateral recess 311. In addition, since the fool-proof bulge 2131 and the fool-proof groove 42 match each other, the charging contact piece 16 can be aligned with and contact the power supply contact piece 6, the external charging interface 7 is communicated with the external power supply, and external power passes through the power supply PCB 5, the power supply contact piece 6, the charging contact piece 16 and charging PCB 15 successively into the battery 13 to realize contact charging.

By providing the charging contact piece 16 of the grinder on the side of the grinder and the power supply contact piece 6 on the side of the upper base upper cap 31, grinding powder can be prevented from dropping onto the charging contact piece 16 or the power supply contact piece 6 when the grinder is placed on the inner recess 43 vertically after use, thereby mitigating the bad contact between the charging contact piece 16 and the power supply contact piece 6 arising from grinding powder.

In addition, after the grinder has been used for a long time, grinding powder would drop into the inner recess 43. In this case, the buckle connection between the upper base lower cap 32 and the lower base 4 may be detached, and the lower base 4 removed and flushed directly to avoid flushing the power supply contact piece 6.

In sum, the present invention provides a grinder, in which the charging contact piece 16 is provided on its side to realize side contact charging, the structures related to the charging function are provided in the upper shell 11, and providing the structures related to the switched-on circuit in the lower shell 21 is avoided.

The above detailed description is for a feasible embodiment of the present invention, and this embodiment is not intended to restrict the protection scope of the present invention. Any equivalent embodiment or change not deviating from the essence of the present invention should be included in the protection scope of the present invention.

It should be noted that for those ordinarily skilled in the art, some transformations and improvements can be made without departing from the conception of the present invention, all of which are within the scope of protection of the present invention. Therefore, the scope of protection of the present invention should be based on the attached claims.

It should also be understood that the components of the system and associated components may be made of any number of different materials and in many different shapes.

Additionally, it should be understood that the various inventive features described above can each be used independently of one another or in combination with other features.

It is appreciated that many changes and modifications could be made to the invention without departing from the spirit thereof. Some of these changes will become apparent from the appended claims. It is intended that all such changes and/or modifications be incorporated in the appending claims.

What is claimed is:

1. A grinder comprising:
an upper shell having a lower end and an inside;
a lower shell having an upper end connected to the lower end of the upper shell;
a PCB;
a charging contact piece having one end connected to the PCB and another end protruding from and exposed on a side of the upper shell; and
a battery connected to the PCB.

2. The grinder of claim 1, wherein the upper shell comprises an inner left shell, an inner right shell, and an upper bottom cap;
wherein the battery and the PCB are built in and connected to one of the inner left shell and the inner right shell;
wherein the another end of the charging contact piece protrudes from and is exposed on the side of one of the inner left shell and the inner right shell;
wherein an upper end of the upper bottom cap is connected to the inner left shell and the inner right shell; and
wherein a lower end of the upper bottom cap is connected to the upper end of the lower shell.

3. The grinder of claim 2, wherein the lower shell comprises:
a feed bin;
a limit bulge provided on an outer side of an upper end of the feed bin;
a limit groove having a first end and a second end provided inside the lower end of the upper bottom cap;
wherein the first end of the limit groove bends down and opens;
wherein the second end of the limit groove extends circumferentially inside the lower end of the bottom cap; and
wherein the limit bulge and the limit groove are connected in a matched manner.

4. The grinder of claim 3, further comprising:
a driving shaft; and
a snap spring;
wherein the lower shell further comprises a bracket connected to the lower end of the feed bin;
wherein the snap spring is connected to a middle of the driving shaft;
wherein the driving shaft passes through a middle fixing hole of the bracket; and
wherein the snap spring abuts against the middle fixing hole of the bracket.

5. The grinder of claim 4, further comprising:
a male grinding head; and
a female grinding head;
wherein the lower shell further comprises a lower bottom cap;
wherein the upper end of the lower bottom cap is connected to a lower end of the bracket;
wherein the male grinding head is connected to the lower end of the driving shaft;
wherein the female grinding head is connected inside the lower bottom cap; and
wherein the male grinding head is located inside the female grinding head.

6. The grinder of claim 5, further comprising a fool-proof bulge inside the lower end of the lower bottom cap.

7. The grinder of claim 5, wherein the lower shell further comprises a lower casing; and
wherein the lower casing fits over the outside of the lower bottom cap.

8. The grinder of claim 1, wherein the PCB further comprises:
a master PCB; and
a charging PCB;
wherein the battery is electrically connected to the master PCB or the charging PCB; and
wherein one end of the charging contact piece is electrically connected to the charging PCB.

9. The grinder of claim 1, further comprising a motor connected inside the upper shell and electrically connected to the PCB.

10. The grinder of claim 1, wherein the charging contact piece is a flexible charging cable.
